(19) United States
(12) Patent Application Publication
(10) Pub. No.: US 2011/0226878 A1
(43) Pub. Date: Sep. 22, 2011

(54) System and method for compressed bed grinding in a stirred media mill

(76) Inventors: Christopher Martin, Birmingham, AL (US); Steven M. Uptain, Childersburg, AL (US); Raymond T. Hemmings, Kennesaw, GA (US)

(21) Appl. No.: 12/932,778

(22) Filed: Mar. 4, 2011

Related U.S. Application Data
(60) Provisional application No. 61/310,682, filed on Mar. 4, 2010.

(51) Int. Cl. B02C 19/00

(52) U.S. Cl. 241/25; 241/101.8; 241/98

(57) ABSTRACT

A system and method are disclosed for the grinding of industrial minerals to fine powders. The system includes a grinding chamber having a generally vertically oriented agitator that is rotated to stir the grinding media intermixed with a feedstock. As the agitator stirs the grinding media and feedstock, there is a retaining plate that is also located within the grinding chamber and positioned atop of the grinding media to prevent the expansion of the grinding media when it is being stirred. The retaining plate has one or more openings to allow the finely ground feedstock to pass upwardly therethrough but to prevent any grinding media from passing through the retaining plate. Introduction of the feedstock may be through one or more hollow support rods that locate the retaining plate in the desired location within the grinding chamber. The support rods are locked into position when the retaining plate is properly located.

### CROSS REFERENCE TO RELATED APPLICATION

The present application is based upon and hereby claims priority to U.S. Provisional Patent Application No. 61/310,682, filed Mar. 4, 2010 and the content of said Provisional patent application is hereby incorporated herein by reference in its entirety.

### FIELD OF THE INVENTION

The present invention relates to methods and equipment for grinding (comminution) of industrial minerals and other related materials to fine powders with equivalent median diameters, and, more particularly, to a method and system for achieving enhanced efficiency in such grinding operations.

### BACKGROUND OF THE INVENTION

There is currently used today a system of dry grinding of industrial rocks and minerals that utilizes a grinding mill known as a vertical stirred media mill and wherein the feedstock is introduced into a bed of a media material in a vertical container, known as a drum, and stirred with a vertical impeller or agitator. The mill can be operated in a continuous or batch process mode.

Typical industrial rocks and minerals suited to the process are: limestone, clays, sand, gravel, diatomite, kaolin, bentonite, gypsum, silica, barite, gypsum, talc, nepheline syenite, mica, pumice, carbon, graphite, fluorspar, shales, inorganic pigments (various metal oxides and compounds), etc. Also cementitious materials, including but not limited to Portland cement, high alumina cement, coal ash (e.g. fly ash, bottom ash, boiler lag, fluidized bed boiler ash, spray drier ash, etc.), blast furnace slag, non-ferrous slag, natural pozzolans, matakaolin, silicate and aluminosilicate glasses, etc. may be utilized.

As described in U.S. Pat. No. 6,802,898 of Liskowitz et al, with a vertical stirred media mill, the media bed expands upwards, increasing its volume, up to 50% or more, depending on the rotational speed of the impeller drive mechanism. This increase in void space significantly reduces the efficiency of energy transfer from the drive system to the grinding media to the feedstock. This operation condition can be described as an “expanded bed” mode and is the mode typically employed by commercial vertical stirred media mills.

As stated in the Liskowitz patent, therefore, if the media bed in the above example is prevented from expanding, by whatever means, the mill is said to be operating in a “compressed bed” mode, sometimes referred to as a “confined bed” mode and the compressed bed mode is preferable as it results in enhanced efficiency (reduced energy consumption, increased production rate).

The Liskowitz patent teaches that the compressed bed mode can be accomplished by operating the impeller at a low speed to minimize the expansion of the media bed. That reduction in speed, however, also has the consequence that there is a decrease in the grinding process efficiency and the ability to grind the feedstock into minute particles, particularly when a size of 1 micron is desired.

Accordingly, it would be advantageous to have a system and method for carrying out vertical stirred bed grinding where the advantage of a confined bed mode of operation is obtained while operating the impeller at a high speed to gain the advantages of both features so as to enhance the efficiency of the grinding process.

### SUMMARY OF THE INVENTION

The present invention provides a method and an apparatus for efficient dry grinding of industrial minerals and other related feedstocks to a material having an ultra-fine particle size (e.g., 1-10 μM median particle size) as a lower cost and more environmentally sound alternative to wet grinding.

The present invention combines the features of a “confined bed' mode of operation with the higher speeds of the agitator to improve efficiency by providing a physical confinement of the bed of grinding media and preventing its normal upward expansion as the agitator rotates to stir the grinding media. In an exemplary embodiment, the confinement of the grinding media is accomplished by introducing a retaining plate into the grinding chamber and which is positioned atop of the grinding media to physically prevent the upward movement of that grinding media during stirring.

This approach enables the mill to be operated in the desirable “compressed bed” mode, but with the added advantage that a range of higher rotational speeds can be employed to further increase the energy input and throughput of the processing.

As such, the present invention includes a system for grinding materials to produce an ultra fine material by utilizing a drum having a grinding chamber lid, thereby forming a grinding chamber within which there is a grinding media and into which the feedstock is introduced. An agitator is vertically oriented in the grinding chamber and is rotated to carry out the stirring of the combined feedstock and grinding media to create the grinding effect and to reduce the feedstock to a finely ground product.

As a further feature of the present inventive system, the retaining plate has at least one hole formed therein that is dimensioned to allow the finely ground product to pass upwardly through the retaining plate while preventing the grinding media from passing though the retaining plate. In an exemplary embodiment, the at least one hole can be a plurality of curved slots.

As a still further feature of the present invention, the retaining plate may be located at a desired position retaining the grinding media by the use of at least one, and preferable two, support rods that extend downwardly through a grinding chamber lid and the retaining plate is suspended by those support rod or rods.

In one exemplary embodiment, the support rods may be hollow and communicate with openings that pass through the retaining plate so as to introduce feedstock as well as grinding media into the grinding chamber through one or both of the support rods. A set of elongated plugs can inserted into the hollow support rods to seal the openings in the retaining plate. With this feature, there is also a locking system to lock the support rods to the grinding chamber lid when the retaining plate has been positioned at its desired location.

The selection of the diameter and nature of the grinding media used in the mill is based on the desired product size of the material to be ground in order to reduce the void space between the grinding media particles. Steel grinding media with diameters in the range 1 mm to 6 mm are typically used. Ceramic grinding media are also often desirable where it is important to maximize the brightness of the ground final mineral product.

The finely ground product produced by this system can be substantially less than 20 μm (microns), and more preferably in the 1 to 10 μm range. The method can achieve products with a median particle size as fine as 1 μm, not otherwise feasible at realistic rates with an “expanded bed” dry mill.

Neglecting edge effects, the void fraction for a packed bed of monodispersed (same size) spherical grinding media is about 40% by volume. The minimum theoretical void fraction is 36% for monodispersed spheres. This leads to an optimal ratio of grinding media to feed of about 60:40 by volume.

When the media bed is confined and the voids between the grinding media are substantially populated with the mineral feedstock, improvements in the efficiency of the system are observed which can be attributed to “autogenous grinding.” In essence, the confined mineral is grinding itself in the void space, thereby reducing wear on the grinding media and ancillary equipment and, further, improving the energy transfer in the mill. The yield of the process is 100%, meaning that all of the feedstock is converted to final product.

While the present invention is particularly adapted to dry grinding and will be hereinafter described as such, it will be seen that it is also suitable for and adaptable to, wet grinding applications with a savings in energy and an increased efficiency.

Other features of the present stirred media grinding mill will become more apparent in light of the following detailed description of a preferred embodiment thereof and as illustrated in the accompanying drawings.

### BRIEF DESCRIPTION OF THE DRAWINGS

FIG. 1 is a perspective view of a vertical compressed bed, stirred medium mill grinding system;

FIG. 2 is a cross sectional view of the internal components of the stirred medium grinding system of FIG. 1;

FIG. 2A is a top view of a retaining plate used with the present invention; and

FIG. 3 is an exploded view illustrating components of the stirred medium grinding system as shown in FIG. 2.

### DETAILED DESCRIPTION OF THE INVENTION

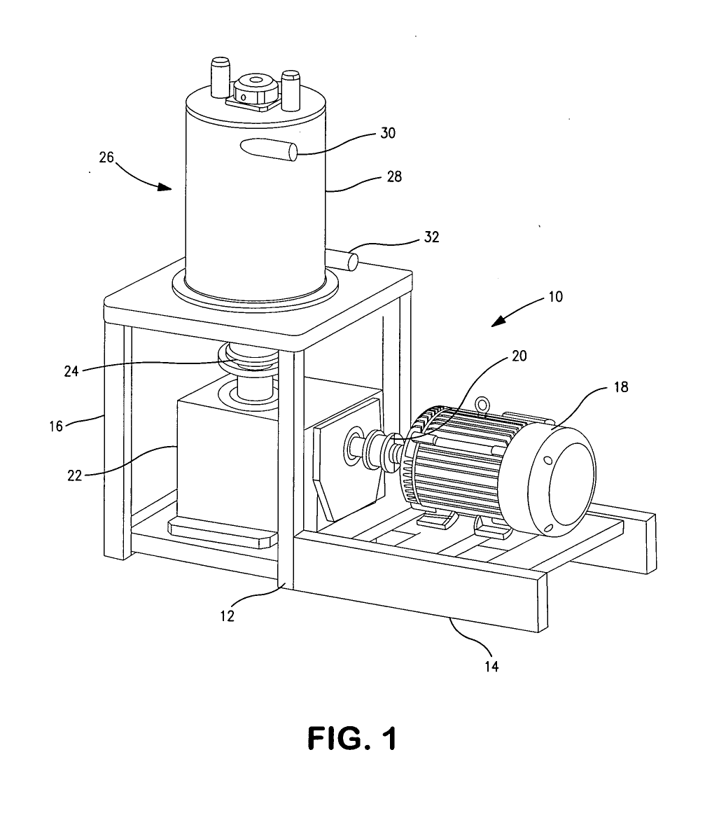

Turning now to FIG. 1, there is shown a stirred bed grinding system 10 constructed in accordance with the present invention. As can be seen, the system 10 is mounted to a frame 12 having a horizontal section 14 and a vertical, raised section 16. A motor 18 is mounted onto the horizontal section 14 and a coupling 20 connects the motor 18 to a gearbox 22 where the rotating power of the motor 20 is converted to a vertical rotating shaft 24 at a predetermined speed.

Mounted to the vertical, raised section 16 is the stirred medium grinding mill 26 and which has an outer, cylindrical enclosure 28 having ports 30 and 32 that are used to circulate a cooling medium, such as water, through the stirred medium grinding mill 26 as will later be explained.

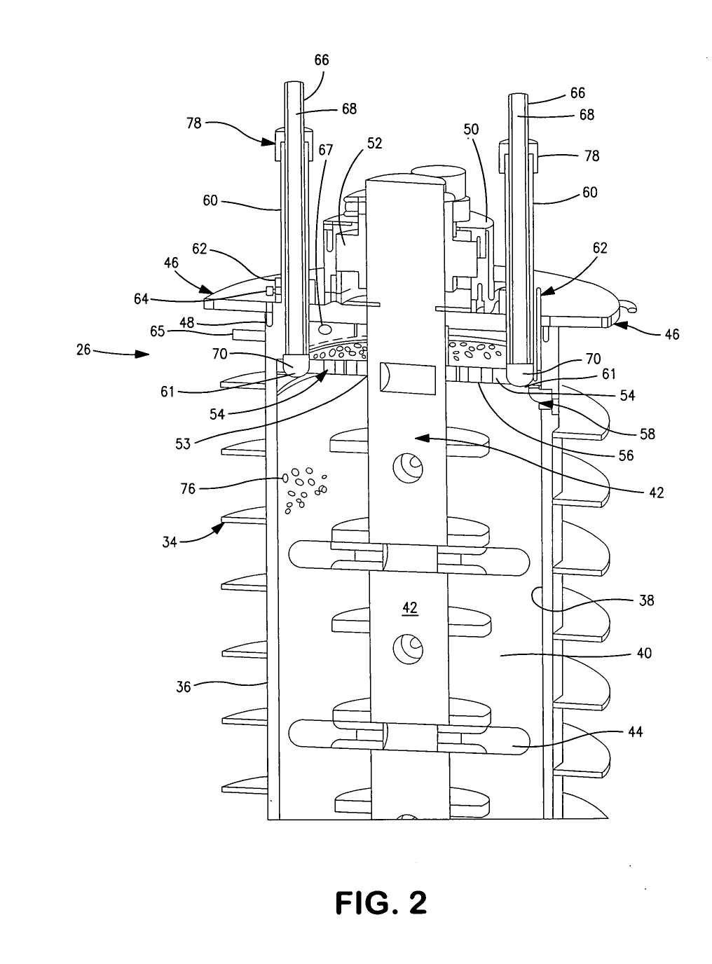

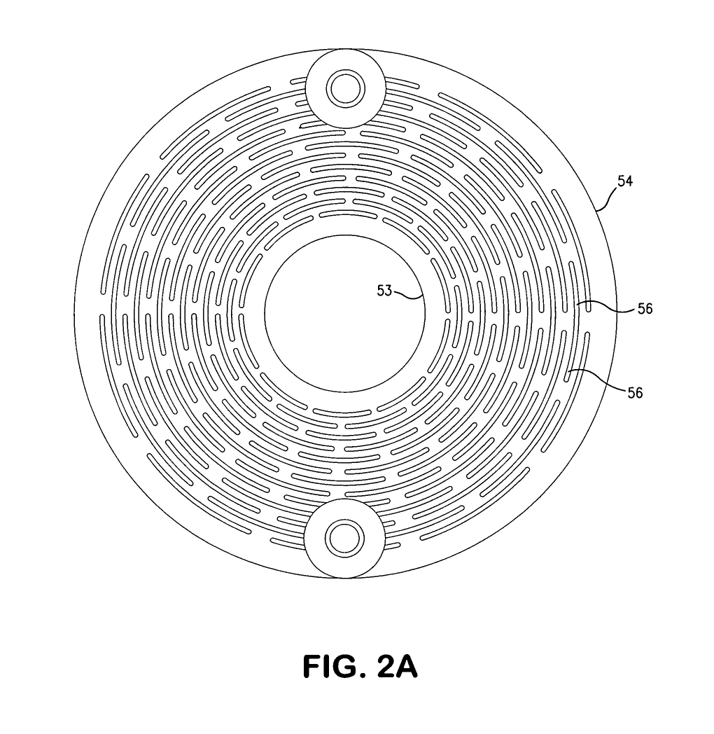

Turning now to FIG. 2, taken along with FIG. 1, there is shown a cross sectional view of a portion of the stirred medium grinding mill 26 of the present invention. As can be seen, there is a spiral flange 34 that traverses the exterior of a drum 36 and which forms the path for the water or other medium that circulates through the grinding mill 26 for cooling purposes. In FIG. 2, the cylindrical enclosure 28 has been removed, however, it is sealed to the outer edges of the spiral flange 34 in order to form the passage for the cooling medium.

Thus, in FIG. 2, the drum 36 has an inner surface 38 that forms a grinding chamber 40 and which contain a grinding media comprised of spherical shaped elements to carry out the grinding of the feedstock. As previously described, the grinding media is selected based upon the desired product size of the material to be ground in order to reduce the void space between the grinding media particles. The composition of the grinding media may vary depending upon the characteristics of the ground final mineral product and may include steel grinding media with diameters in the range 1 mm to 6 mm. Ceramic grinding media are also often desirable where it is important to maximize the brightness of the ground final mineral product.

Within the grinding chamber 40 is an agitator shaft 42 that is connected to, and, therefore, rotated by, the vertical rotating shaft 24 and there are a plurality of paddles 44 that are affixed to the agitator shaft 42 to carry out that grinding process. Basically, as the agitator shaft 42 is rotated, the paddles 44 stir up and agitate the grinding media mixed with the feedstock to grind the feedstock into the desired fineness.

The upper opening of the grinding chamber 40 is closed by a grinding chamber lid 46 that may be secured to the drum 36 by means such as bolts 48. Mounted to the grinding chamber lid 46 is a bearing housing 50 to contain the upper bearing 52 for the agitator shaft 42.

A retaining plate 54 is located within the grinding chamber 40 and the retaining plate 54 is a circular plate, fabricated and machined from wear-resistant material, that slides over the agitator shaft 42 with tight tolerance between the agitator shaft 42 and a shaft hole 53 formed in the center of the retaining plate 54 and between the outside diameter of retaining plate 54 and the inner surface 38 of the drum 36. The wear resistant retaining plate 54 can be constructed of a variety of materials, including but not limited to hardened steel, ceramic coated steel, ceramic, or other suitable materials.

As shown in FIG. 2A, taken along with FIG. 2, the retaining plate 54 has a plurality of arcuate, spaced slots 56 that are cut into the retaining plate 54 at intervals and, in the exemplary embodiment, the slots 56 are arcs of circles having different radii and having a common center point. The width of the curved slots 56 is such that microfine dust-laden, air may pass through the slots 56 but grinding media is constrained below the retaining plate 54 and cannot pass through the slots 56 in the retaining plate 54.

In the exemplary embodiment, the slots 56 are curved, however, it can be seen that the slots 56 may take other configurations or may be a drilled hole or holes, it being of importance that size of the slots 56 be such that the grinding median cannot pass therethrough such that the retaining plate 54 acts to constrain the upward movement of the filter media as it is stirred and acts to create a compressed mode of the stirred bed grinding system 10. In such a mode, the dust within the air is the product thereby produced and the grinding media is used to produce that product. Alternate embodiments include different aperture sizes and shapes of the slots within the retaining plate, as well as different materials of construction for all components.

The retaining plate 54 is shown in FIG. 2 as resting on an optional hard stop 58 within the drum 36, and the retaining plate 54 can be located at that position relative to the grinding chamber lid 46 lid of the drum 36 by means of two support rods 60, which are hollow in nature. These support rods 60 can be threadedly engaged to, or may be welded to the retaining plate 54 at the distal ends of the support rods 60 and are free to slide axially through stanchions 62 that are rigidly affixed to the upper surface of the grinding chamber lid 46.

In an exemplary embodiment, the support rods 60 are locked into place retaining the retaining plate 54 at a desired distance or depth from the grinding chamber lid 46 (or “constraining depth”) by means set screws 64, and preferably three set screws 64 per support rod 60 (only one of which is shown) and the set screws 66 are threaded into the stanchions 62.

Alternatively, the outside diameter of the support rods 60 can be externally threaded and threadedly engage internal threads formed in the inner diameter of the corresponding stanchions 62. This arrangement of support rods 60 is thus infinitely adjustable so that the location of the retaining plate 54 and thus the volume of the grinding media being constrained can be readily adjustable by the user.

Since the support rods 60 are hollow, and can communicate with the grinding chamber 40 through holes 61 in the retaining plate 54, feedstock as well as grinding media can be introduced into the grinding chamber 40 through one or both of the support rods 60. While there are various systems that can be used to recover the finely ground powder from the grinding chamber 40, one means illustrated in the exemplary embodiment is by the use of an outlet conduit 65 that communicates with an opening 67 into the interior of the grinding chamber 40 above the retaining plate 54 and a pneumatic system can be used to withdraw the finely ground product therefrom.

Within each hollow support rod 60, there is shown an elongated plug 66, which consists of a hollow rod 68 of smaller diameter than the inner area of the support rods 60 such that the hollow rod has a plug shaped piece 70 at the distal end, and threads formed at the proximal end. This elongated plugs 66 slide down into the support rods 60 to plug the holes 61 that have been precisely match machined into the retaining plate 54 corresponding to the centerline of each support rod 60.

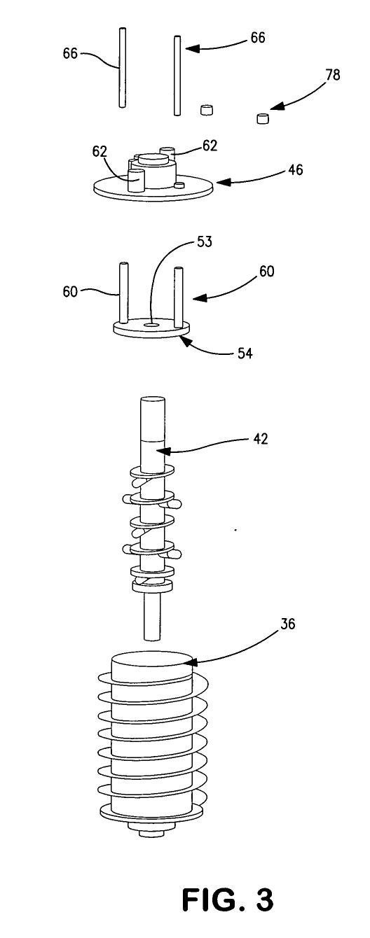

Turning finally to FIG. 3, taken along with FIGS. 1 and 2, it can be seen that the assembly of the stirred bed grinding system 10 can be carried out by inserting the retaining plate 54 and support rod 60 subassembly into the stanchions 62 and locking the retaining plate 54 in its desired location with respect to the grinding chamber lid 46. The agitator shaft 42 can then be slid through the opening 53 in the retaining plate 54 and installed through the grinding chamber lid 46 and upper bearing 52. Accordingly, the entire assembly may then be lowered into the grinding chamber 40 and the grinding chamber lid 46 secured to the drum 36 by the bolts 48.

Grinding media 76 may then be poured into the one or both of the hollow support rods 60 to fill the grinding chamber 40. Once the grinding media 76 has filled the grinding chamber 40 completely, the elongated plugs 66 can be inserted into the hollow support rods 60 and secured in place by means of threaded fasteners 78 which lock on the outer diameter of the elongated plugs 66 and the outer diameter of the top end of the support rods 60. This is a significant advantage over all other designs in that grinding media 76 can easily added to the grinding chamber 40 after the entire assembly is installed, rather than required the grinding media to be drained and the entire assembly be removed and disassembled, should one desire to change the amount of grinding media within the mill.

Another advantage of the design is that, due to the hollow nature of the support rods and the ability of the elongated plugs to protrude into the grinding zone, temperature and force measurements may easily be obtained, whereas, in previous designs such was impossible, due to the violent nature of the grinding within the chamber.

While the present invention has been set forth in terms of a specific embodiment of embodiments, it will be understood that the present stirred bed grinding system herein disclosed may be modified or altered by those skilled in the art to other configurations. Accordingly, the invention is to be broadly construed and limited only by the scope and spirit of the claims appended hereto.

What is claimed is:

1. A system for grinding materials to produce ultra fine material comprising:
a drum having an inner surface and a grinding chamber lid defining a grinding chamber, the grinding chamber adapted to contain a quantity of a grinding media,
an agitator shaft positioned within the grinding chamber and having a plurality of paddles extending therefrom,
an inlet for introducing a feedstock into the grinding chamber to mix with the grinding media,
a motor to rotate the agitator shaft at a predetermined speed to provide stirring of the grinding media and feedstock within the grinding chamber to grind the feedstock to an ultra fine material,
a retaining plate located within the grinding chamber, the retaining plate having at least one opening therethrough, said at least one opening being dimensioned to allow the ultra fine material to pass through the retaining plate but to prevent grinding media from passing therethrough, and
an outlet conduit for removing the ultra fine material from the grinding chamber.

2. The system of claim 1 wherein retaining plate is suspended into the chamber by means of at least one support rod.

3. The system of claim 2 wherein the retaining plate has at least one hole therethrough and the at least one support rod is hollow and communicates with the grinding chamber through the at least one hole.

4. The system of claim 1 wherein the at least one support rod comprises two hollow support rods.

5. The system of claim 3 further including an elongated plug is adapted to enter into the at least one support rod and plug the hole in the retaining plate.

6. The system of claim 5 further including a plug locking system to securely lock the elongated plug within the at least one support rod.

7. The system of claim 3 wherein the inlet is through the at least one hollow support rod.

8. The system of claim 1 wherein a locking system is provided to lock the support rods to the cover when the retaining plate is at a desired position.

9. The system of claim 1 wherein the outlet conduit is located between the retaining plate and the grinding chamber lid.

10. The system of claim 1 wherein the at least one opening in the retaining plate comprises a plurality of curved slots.

11. A method of grinding a feedstock comprising the steps of:
providing a grinding chamber having a grinding medium contained therein, the grinding chamber having an agitator located therein
introducing the feedstock into the grinding chamber,
rotating the agitator to cause stirring of the feedstock and grinding media,
physically confining the expansion of the grinding media when the agitator is stirring the grinding media and feedstock.

12. The method of claim 11 where the step of physically confining the expansion of the grinding media comprises preventing vertical movement of the grinding media.

13. The method of claim 11 where the step of physically confining the expansion of the grinding media comprises placing a retaining plate atop of the grinding media to prevent upward movement thereof.

14. The method of claim 13 further including the step of vertically moving the retaining plate to physically confine the grinding media to a predetermined vertical height.

15. The method of claim 14 wherein the step of vertically moving the retaining plate comprises providing at least one hollow support rod affixed to the retaining plate and adjusting the position of the at least one hollow support rod to vertically move the retaining plate.

16. The method of claim 15 wherein the step of introducing the feedstock into the grinding chamber comprises introducing the feedstock through the at least one hollow support rod.

17. The method of claim 14 further including the step of locking the at least one hollow support rod at a desired position with respect to the grinding chamber.

18. A vertical grinding mill for producing a finely ground product comprising:
an enclosed grinding chamber having a grinding chamber lid,
an agitator movable disposed within the grinding chamber;
an inlet for introducing a feedstock into the grinding chamber,
a quantity of a grinding media within the grinding chamber, said agitator being movable to stir the combined grinding media and feedstock within the grinding chamber to reduce the feedstock to a finely ground material,
a retaining plate located within the grinding chamber atop of the grinding medium to suppress the expansion of the grinding media when the agitator is stirring the grinding media and feedstock, and
an outlet for withdrawing the finely ground material.

19. The vertical grinding mill of claim 18 wherein the retaining plate has openings that are dimensioned to allow the finely ground material to pass therethrough but prevent the grinding media from passing therethrough.

20. The vertical grinding mill of claim 18 wherein the outlet is located between the retaining plate and the grinding chamber lid.

21. Then vertical grinding mill of claim 19 wherein the openings in the retaining plate are arcs of concentric circles having different radii.
